(19) United States
(12) Patent Application Publication
(10) Pub. No.: US 2004/0172452 A1
(43) Pub. Date: Sep. 2, 2004

(54) Service provider model for real-time services

(76) Inventors: Paul R. Erickson, Sammamish, WA (US); Jordan L.K. Schwartz, Seattle, WA (US); Peyman Oreizy, Kirkland, WA (US); Andrew F. Boardman, Redmond, WA (US); Walter R. Smith, Seattle, WA (US); Deana R. Fuller, Seattle, WA (US)

Correspondence Address: RICK D. NYDEGGER, WORKMAN, NYDEGGER & SEELEY, 1000 Eagle Gate Tower, 60 East South Temple, Salt Lake City, UT, 84111, US

(21) Appl. No.: 10/376,901

(22) Filed: Feb. 28, 2003

(51) Int. Cl. G06F 15/16

(52) U.S. Cl. 709/206

(57) ABSTRACT

The present disclosure recites methods, systems, and computer program products for selecting an appropriate service provider for a real-time communication activity with a contact using a single user interface. Each of one or more contacts may have one or more real-time addresses corresponding to distinct service providers. A selection module determines which service providers support a requested real-time communication activity for a contact, producing a subset of service providers. From the subset, a service provider for a real-time communication activity for a particular contact may be selected from a single user interface.

### CROSS-REFERENCE TO RELATED APPLICATIONS

N/A.

### BACKGROUND OF THE INVENTION

1. The Field of the Invention

The present invention relates to real-time communication, particularly with respect to methods, systems, and computer program products for selecting an appropriate service provider for a given real-time electronic communication activity through a single interface.

2. The Relevant Technology

The popularity of the Internet and satellite-based technologies has enhanced the way people communicate with each other by allowing users quick and easy access to a virtually endless sea of communication methods. Any given person may now contact another person with greater or lesser immediacy using various media, including the World Wide Web, electronic mail (email), satellite-based or Internet-based telephony, video conferencing, and instant text messaging. These methods allow people to stay in touch with each other around the globe, and to access information on an almost limitless variety of subjects, in some cases instantly.

Just as the methods by which people may contact each other have expanded, so too have the numbers of addresses by which people can be reached. Multiple addresses can impede communication. For example, when email was introduced initially, users could only send email to other users who had the same software, or were on the same email network. Similarly, with the advent of instant text or video messaging, typically only those users who subscribe to a specific instant messaging service using the same software may contact each other via that specific messaging service's network and user interface. Thus, as in the prior case with email, users of real-time communications have had to install service specific software, and in many cases, subscribe to multiple instant messaging service providers, each of which requires a separate real-time address.

Of course, email has now moved to a common system where only one contact address is needed to communicate with a user on a different network. Users can send email back and forth to each other without downloading each respective user's proprietary software or maintaining multiple email addresses. In contrast, real-time communication protocols, such as instant messaging services, continue to rely on exclusive networks and exclusive software for inter-user communication.

As a result, instant message users subscribing to one network cannot send real-time text or video messages to users of another network, and vice versa, without installing software specific to the other network. Users, therefore, install a separate user interface for each service provider and gain a corresponding real-time address for each. Accordingly, users wishing to contact other users through different instant messaging networks must keep a separate user interface open for each ongoing message session, wasting valuable computer display real estate.

With the continued grown in the popularity of the Internet and satellite-based communications, the number of devices communicating on these media have increased as well. Devices such as mobile phones, pagers personal digital assistants, televisions, and the like, increasingly are used to communicate with others on the Internet. With the growth of device types, it is becoming more probable that two users who wish to engage in a messaging session will not be using a convention computer. For example, one user may be accessible by a mobile phone, whereas the second uses a desktop computer.

As might be expected, the multiple numbers of devices per user compounds the complexity of contacting that user over different, software-exclusive networks. For example, just as a contact may have several email addresses on different servers (e.g., someone @microsoft.com, someone@yahoo.com), and several telephone numbers (local, toll free, mobile, facsimile, etc.), a user also may have several different real-time messaging addresses, depending, for example, on the device where the contact may be reached. As a general rule, a user's selection of a particular real-time messaging address has been tied to the user's selection of a particular user interface for a particular service provider, without any prioritization of addresses based on information about a contact, a service provider, or user's computing environment.

No known messaging service offers support for real-time communication with one or more contacts using any of one or more real-time addresses and a single user interface, or prioritization of real-time addresses for different service providers. Moreover, no known messaging system allows for selecting an appropriate real-time communication address given a plurality of choices.

Accordingly, what is desired are systems, methods, and computer program products that allow for selecting an appropriate service provider for a given real-time electronic communication activity through a single interface.

### BRIEF SUMMARY OF THE INVENTION

The present invention describes a solution to the above problems by presenting a contact-centric selection module that allows real-time communication among a user and one or more contacts, each having differing service providers. More particularly, in a real-time electronic communication environment having one or more contacts, and one or more service providers implementing one or more communication services, the selection module relays instant electronic communication for a plurality of contacts without requiring the use of a separate interface for each communication service.

As may be implemented, the selection module receives a request to communicate with a contact, the contact having at least one real-time address for one or more real-time electronic communication activities through a service provider. The user's request may identify a particular communication activity such as whether the communication should be, e.g., an instant message, chat, videoconference, or game, etc. To facilitate the interaction, a selection module determines or identifies which of the available service providers support the requested communication activity for a specified contact.

In the case where a contact may have a plurality of real-time addresses through different providers, the selection module may prioritize the real-time address for any given method of communication activity for certain providers. Once the selection module determines which real-time addresses are available for a communication activity, one or more of the available real-time addresses may be used.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by references to specific embodiments thereof, which are illustrated in the appended drawings. These drawings depict only typical embodiments of the invention and are therefore not to be considered limiting of its scope. The invention will be described and explained with additional specificity and detail through the use of the accompanying drawings in which:

FIG. 1 illustrates a prior art depiction of a computer screen having several applications open, including a plurality of instant message applications.

FIG. 2 illustrates an example contact with various addresses, including real-time addresses.

FIG. 3 illustrates a flowchart depicting an example implementation of the present disclosure.

FIG. 4 illustrates an example action diagram of the present disclosure where a user wishes to communicate in real-time with a contact.

FIG. 5 illustrates a representation between a user and a potential contact, where the contact and user do not have the same service providers.

FIG. 6 illustrates a second example flow chart relating functional steps and non-functional acts of the present invention.

FIG. 7 illustrates an example system that provides a suitable operating environment for the present invention.

### DETAILED DESCRIPTION OF THE PREFERRED EMBODIMENTS

The present invention extends to methods, systems, and computer program products for a service provider selection model of real-time services. The embodiments of the present invention may comprise a special purpose or general-purpose computer including various computer hardware, as discussed in greater detail below.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disc storage, magnetic disk storage or other magnetic storage devices, or any other medium which can be used to carry or store desired program code means in the form of computer-executable instructions or data structures and which can be accessed by a general purpose or special purpose computer.

When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

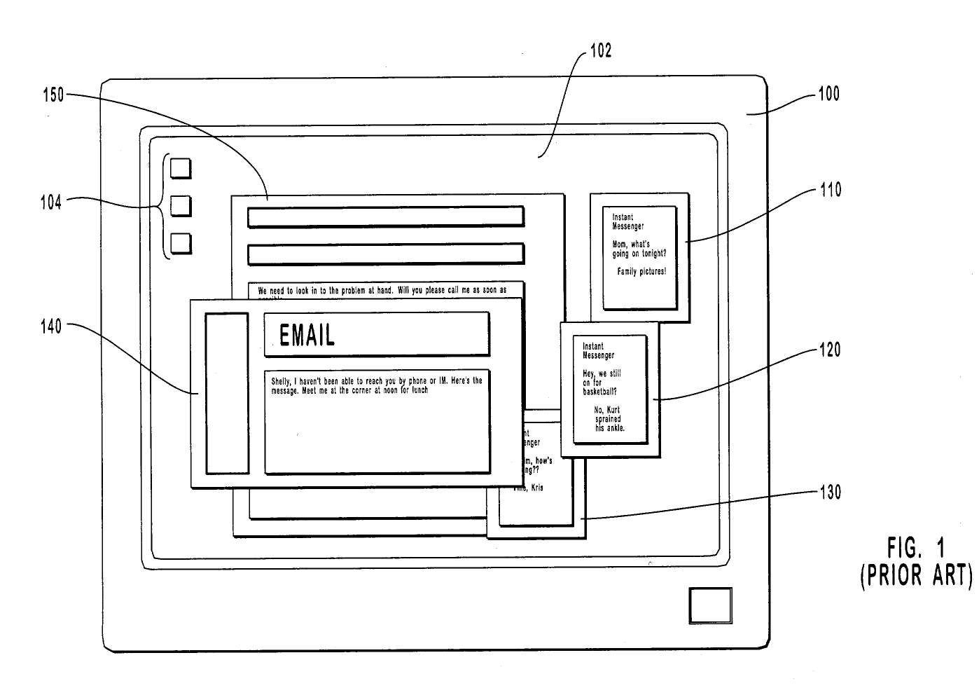

FIG. 1 illustrates a prior art system with multiple applications open on a desktop screen 102 having a graphical user interface (GUI). More particularly, an exemplary monitor 100 has a general viewing screen 102 with application icons 104 residing therein.

FIG. 1 shows at least one problem in the prior art. As depicted, word processing application 150 is obscured by email interface 140 and instant message interface 130. Instant message interface 130 is itself obscured by email interface 140 and instant message interface 120. Instant message interface 110 is also shown in FIG. 1 occupying the desktop screen real estate. As a result, for a user to monitor the instant message conversations 110, 120, and 130, as well as to reference the word processing document 150 or email 140, the user is forced to toggle between each of the different interfaces.

In the case of FIG. 1, a user may be required, alternatively, to selectively arrange or resize the various interfaces on the screen in order to monitor the interfaces 110, 120, 130, 140, and 150 at once. While most present operating systems having a GUI provide this ability for a user to selectively arrange various interfaces, it is less desirable to require a user to maintain separate, open interfaces for each application, particularly in the real-time communications context. It should be appreciated that multiple interfaces can be a burden to both system resources as well as the user, and therefore, to the nature of real-time communication itself.

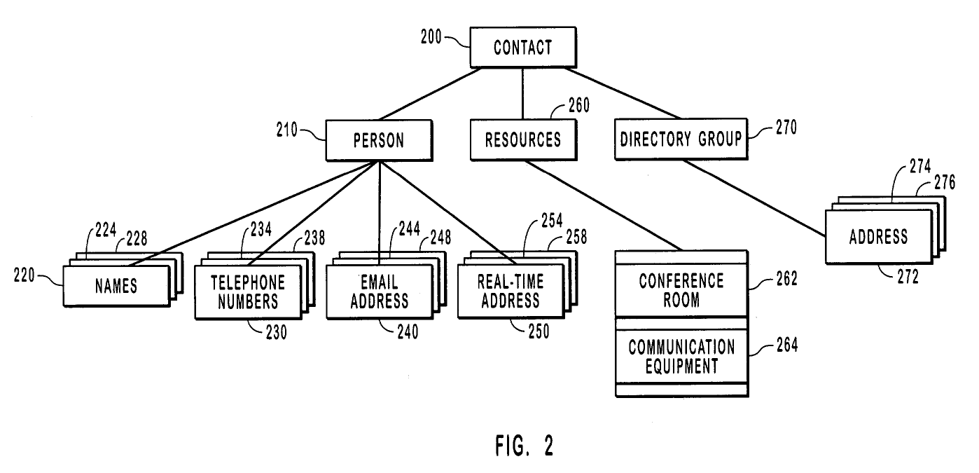

FIG. 2 illustrates an example representation of a contact, e.g., contact 200, in accordance with the present invention. Contact 200 may be represented as a person 210, a set of resources 260, a directory group 270, etc. As used in this application, a contact should be interpreted broadly to encompass any entity capable of sending, receiving, or otherwise participating in real-time communication. A person 210, for example, may be represented by a collection of names 220, including individual names 224 and 228; a set of telephone numbers 230, including individual telephone numbers 234 and 238, whether by satellite, Internet, or standard telephony; a set of email addresses 240, including individual email addresses 244 and 248; and a set of real-time addresses 250, including individual addresses 254 and 258, etc. While this depiction in FIG. 2 represents one common way of representing a person 210 as a contact, it certainly is not an exhaustive list. In particular, a person could also be contacted through one or more Internet Protocol (IP) addresses on various devices.

As further shown in FIG. 2, a contact 200 also may represent a set of resources 260, such as a conference room address 262, and communication equipment address 264. In this particular example, the resources may be used for scheduling, video or audio conferencing, etc. A contact 200 can also take the form of a directory group 270. Directory group 270 contains a plurality of addresses (272, 274, 276) representing one or more users, an entire electronic address set for a company, or some combination thereof, etc. When a user sends a message to a directory group 270, the message is routed to the addresses of each of the members (272, 274, 276) of the directory group 270.

While a contact 200 (person 210, resource 260, and/or directory group 270) may be communicated with as described, FIG. 2 is merely representative of a potential organization of communication options and addresses for a given contact 200. Of course, the types of contacts illustrated in FIG. 2 are examples only.

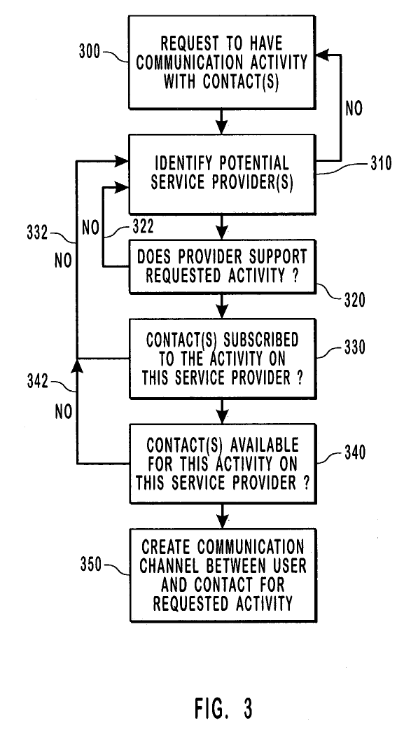

FIG. 3 illustrates a flow chart showing methods of practicing the present invention. In FIG. 3, a user may request (300) real-time communication with one or more contacts having one or more real-time communication addresses through a single user interface that is not specific to any particular service provider. Accordingly, the selection module identifies (310) one or more potential service providers, such as those associated with one of the contact's real time addresses. It should be appreciated that, although in one embodiment the selection module may inquire of the capabilities of service providers associated with a contact's real-time address, a selection module may not necessarily be limited to those providers. For example, a selection module may inquire of several different service providers—to which the contact may or may not be subscribed—to first discover a respective service provider's capabilities.

In any case, the selection module asks (320) a particular provider whether the provider supports the requested real-time communication activity. If the provider does not support (322) the activity, the selection module's inquiry ends for that provider, and the selection module identifies (310) another provider, if one is available. If the particular provider does provide the requested service, the selection module inquires (330) whether a specific contact or contacts are subscribed for the requested activity on this service provider. If the contact or contacts are not subscribed, the selection module's inquiry ends (332) for that provider, and the selection module identifies (310) another service provider, if one is available. If the provider does provide the service, and the subscriber is subscribed for the activity, the selection module inquires (340) whether the contact or contacts are currently available for the requested activity. If the contact or contacts are currently available, a real-time communication channel between the user and contact for the requested activity is created (350). If, on the other hand, the contact or contacts are unavailable (342), the selection module identifies (310) another service provider, if another service provider is available. One should note that different contacts may use different service providers.

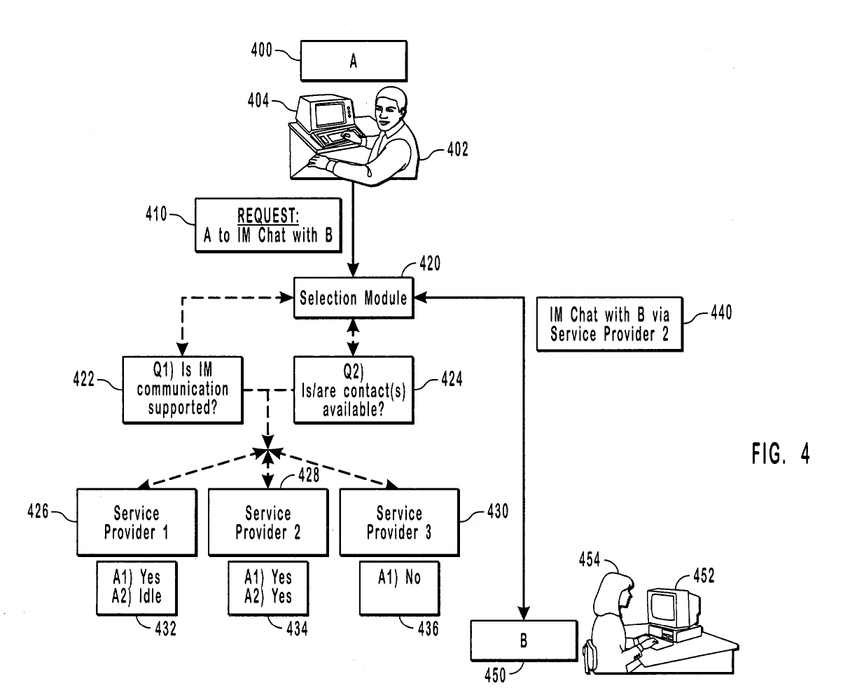

FIG. 4 illustrates one implementation of the flowchart shown in FIG. 3. In FIG. 4, user A (400) desires to communicate through an instant messaging service with contact B (450) that has three or more real-time communication addresses (one for each service provider). One should note for clarity that some of the Figures depict the case of one user communicating in real-time with one contact. The invention, however, should not be construed as limited to the single contact case, which may be readily practiced by a user communicating with a plurality of contacts, and vice versa. In this example, person (404) and client computer (402) represent user (400); similarly, person (454) and client computer (452) represent contact B (450).

To establish an instant messaging channel (440), between person A (404) and person B (454), person A (404) first initiates a request (410) via the client system. Here, the selection module (420) is shown inquiring of three different service providers (i.e., 426, 428, and 430): 1) Is instant messaging (IM) communication supported (422) by this service provider? And if so, 2) is person B currently available (424) for this communication activity? Again, one should note that this inquiry could apply to multiple contacts, rather than simply for person B.

Each service provider responds to the selection module (420) with an answer set (432, 434, and 436). For example, service provider 1 (426) replies (432) that it does support instant message communication, but that the subscriber (in this case person B 454) is currently idle, or otherwise unavailable for the service. Service provider 2 (428) replies (434) that it does support instant message communication, and that the subscriber is currently available for communication. Service provider 3 (430) replies (436) that it does not support the requested instant message communication activity, thus ending the inquiry from Service Module (420).

With the results of the inquiry returned, the requested instant message communication between person A (404) and person B (454) occurs using service provider 2 (428). While it is not shown in FIG. 4 explicitly, person A (402) has subscribed to each of the service providers. This allows for person A (404) to interact with a single user interface, independent of the particular service provider through which the real-time communication occurs.

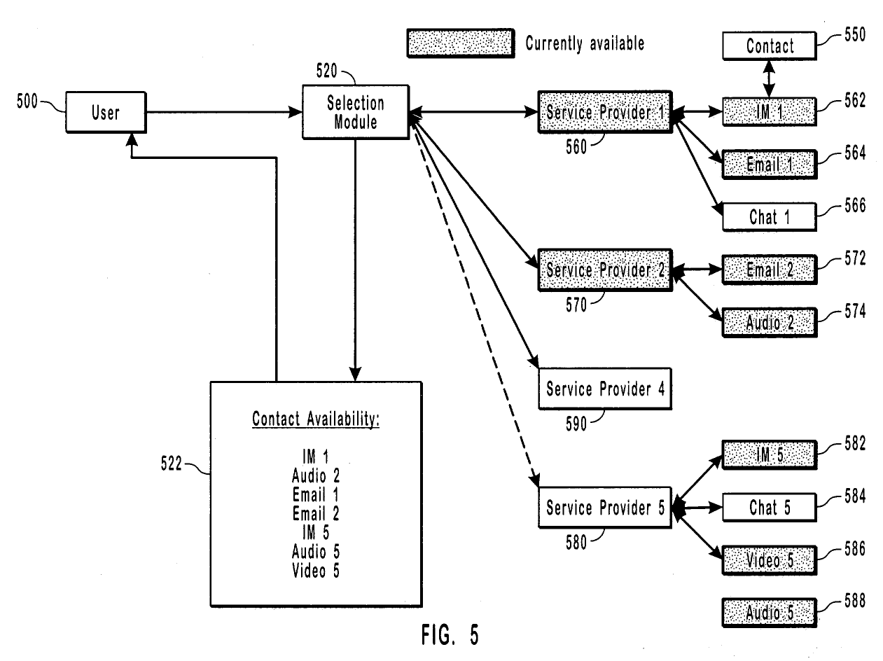

FIG. 5 illustrates another embodiment of the present invention where User 500 has installed on its system service providers 1 (560), 2 (570), and 4 (590). Contact 550 has installed on its system service providers 1 (560), 2 (570), and 5 (580). For contact 550, service provider 1 (560) supports instant messaging 1 (IM1) (562), email 1 (564), and chat 1 (566). Service provider 2 (570) supports email 2 (572), and audio 2 (574). Service provider 5 (580) supports IM 5 (582), chat 5 (584), video 5 (586), and audio 5 (588).

User 500 may wish to communicate with contact 550 and engages selection module 520 to determine an appropriate communication channel, based on, for example, the real-time addresses that user 500 maintains for contact 550. Selection module 520 inquires of service provider 1 (560), service provider 2 (570), and service provider 5 (580), to find out whether they support real-time communication activities, whether contact 550 is subscribed to the requested activities on the service providers (560, 570, and 580), and whether contact 550 is currently available. (No inquiry is made of service provider 4 (590) because user 500 does not have a real-time address for contact 550 that corresponds to service provider 4.) Selection module 520 receives a response from each service provider (i.e., 560, 570, and 580) that contact 550 is available on IM 1 (562), email 1 (564), email 2 (572), audio 2 (574), IM5, (582), video 5 (586), and audio 5 (588).

Selection module 520 recognizes, however, that user 500 has not subscribed to any activities on service provider 5 (580), which is illustrated in FIG. 5 by a dashed line between selection module 520 and service provider 5, and is only subscribed to activities on service providers 1, 2, and 4, (510, 512, and 514 respectively). Contact availability 522 identifies supported communication activities and corresponding service providers for contact's 550 availability. The list may be prioritized based on a variety of factors, such as the user's 500 preference for communication, the contact's 550 preference for communication, prior cost arrangements with certain service providers, availability of future subscription, quality of service, prior experience, and the like, including combinations thereof.

Of course, selection module 520 may only inquire for specific types of communication activities, such as instant messaging, so that only service providers for instant messaging are provided. Selection module may stop asking whether individual service providers can provide real-time communication with a contact after a first service provider is identified. Additionally, it is worth noting that selection module 520 may identify service providers that user 500 (i.e., services on service provider 5 (580)) has not installed or are not currently available to user 500, allowing user 500 the option of subscribing to a new service provider, if desired, to reach contact 550. The contact availability 522 may be stored for future reference, including any information gathered with respect to the real-time communication experience. This stored contact availability 522 may be helpful in establishing future real-time communication with a contact.

The present invention also may be described in terms of methods comprising functional steps and/or non-functional acts. The following is a description of acts and steps that may be performed in practicing the present invention. Usually, functional steps describe the invention in terms of results that are accomplished, whereas non-functional acts describe more specific actions for achieving a particular result. Although the functional steps and non functional acts may be described or claimed in a particular order, the present invention is not necessarily limited to any particular ordering or combination of acts and/or steps.

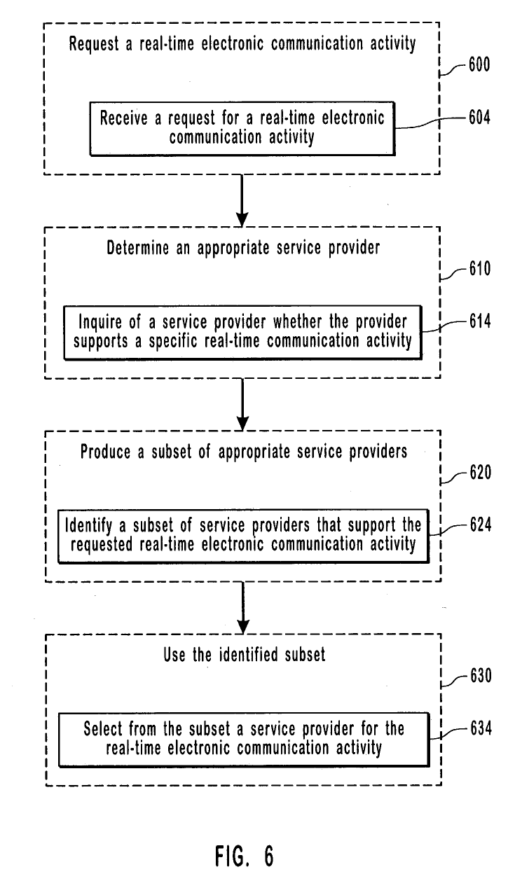

FIG. 6 shows example acts and steps for methods of processing real-time communication requests in accordance with the present invention. A step for requesting (600) a real-time electronic communication activity may include the specific act of receiving (604) a request for a real-time electronic communication activity. A step for determining (610) an appropriate service provider may include the specific act of inquiring (614) of a service provider whether the provider supports a specific real-time communication activity for a particular contact. A step for producing (620) a subset of appropriate service providers may include the specific act of identifying (624) a subset of service providers that support the requested real-time electronic communication activity for a contact. Finally, a step for using (630) the identified subset may include the specific act of selecting (634) from the subset a service provider for the real-time electronic communication activity. While the present invention may not be constrained by the order shown in FIG. 6, one embodiment of the present invention may be accomplished this way.

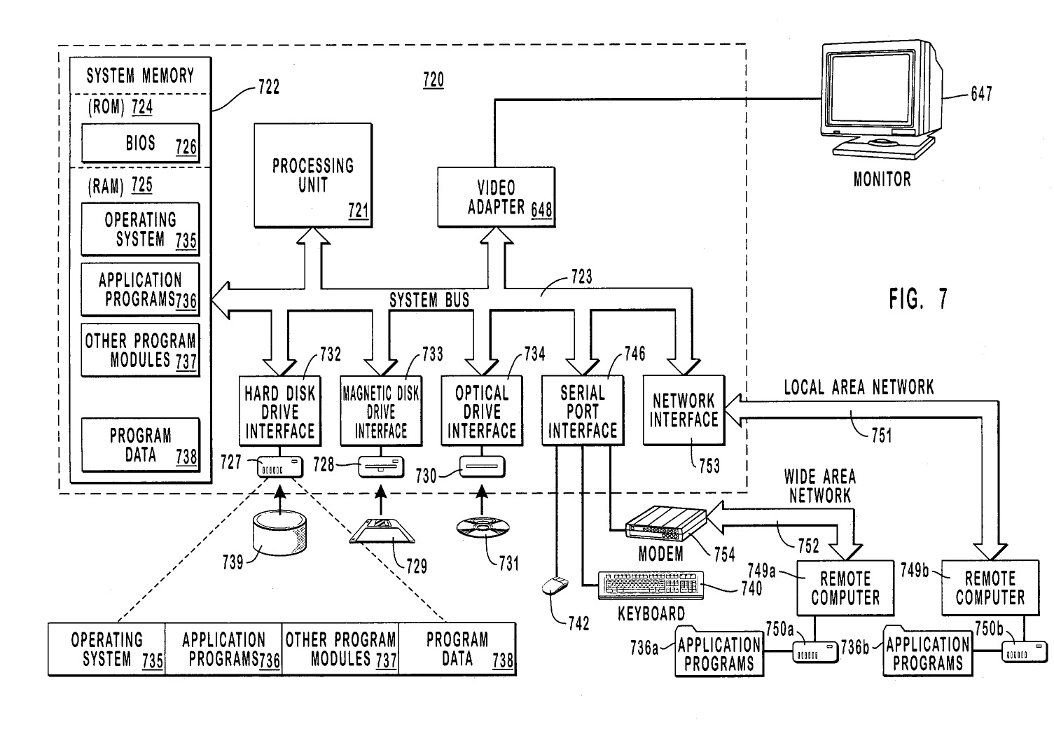

FIG. 7 and the following discussion are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those skilled in the art will appreciate that the invention may be practiced in network computing environments with many types of computer system configurations, including personal computers, hand-held devices, multi-processor systems, microprocessor-based or programmable consumer electronics, network PCs, minicomputers, mainframe computers, and the like. The invention may also be practiced in distributed computing environments where local and remote processing devices perform tasks and are linked (either by hardwired links, wireless links, or by a combination of hardwired or wireless links) through a communications network. In a distributed computing environment, program modules may be located in both local and remote memory storage devices.

With reference to FIG. 7, an exemplary system for implementing the invention includes a general-purpose computing device in the form of a conventional computer 720, including a processing unit 721, a system memory 722, and a system bus 723 that couples various system components including the system memory 722 to the processing unit 721. The system bus 723 may be any of several types of bus structures including a memory bus or memory controller, a peripheral bus, and a local bus using any of a variety of bus architectures. The system memory includes read only memory (ROM) 724 and random access memory (RAM) 725. A basic input/output system (BIOS) 726, containing the basic routines that help transfer information between elements within the computer 720, such as during start-up, may be stored in ROM 724.

The computer 720 may also include a magnetic hard disk drive 727 for reading from and writing to a magnetic hard disk 739, a magnetic disc drive 728 for reading from or writing to a removable magnetic disk 729, and an optical disc drive 730 for reading from or writing to removable optical disc 731 such as a CD ROM or other optical media. The magnetic hard disk drive 727, magnetic disk drive 728, and optical disc drive 730 are connected to the system bus 723 by a hard disk drive interface 732, a magnetic disk drive-interface 733, and an optical drive interface 734, respectively. The drives and their associated computer-readable media provide nonvolatile storage of computer-executable instructions, data structures, program modules and other data for the computer 720. Although the exemplary environment described herein employs a magnetic hard disk 739, a removable magnetic disk 729 and a removable optical disc 731, other types of computer readable media for storing data can be used, including magnetic cassettes, flash memory cards, digital versatile disks, Bernoulli cartridges, RAMs, ROMs, and the like.

Program code means comprising one or more program modules may be stored on the hard disk 739, magnetic disk 729, optical disc 731, ROM 724 or RAM 725, including an operating system 735, one or more application programs 736, other program modules 737, and program data 738. A user may enter commands and information into the computer 720 through keyboard 740, pointing device 742, or other input devices (not shown), such as a microphone, joy stick, game pad, satellite dish, scanner, or the like. These and other input devices are often connected to the processing unit 721 through a serial port interface 746 coupled to system bus 723. Alternatively, the input devices may be connected by other interfaces, such as a parallel port, a game port or a universal serial bus (USB). A monitor 747 or another display device is also connected to system bus 723 via an interface, such as video adapter 748. In addition to the monitor, personal computers typically include other peripheral output devices (not shown), such as speakers and printers.

The computer 720 may operate in a networked environment using logical connections to one or more remote computers, such as remote computers 749a and 749b. Remote computers 749a and 749b may each be another personal computer, a server, a router, a network PC, a peer device or other common network node, and typically include many or all of the elements described above relative to the computer 720, although only memory storage devices 750a and 750b and their associated application programs 736a and 736b have been illustrated in FIG. 7. The logical connections depicted in FIG. 7 include a local area network (LAN) 751 and a wide area network (WAN) 752 that are presented here by way of example and not limitation. Such networking environments are commonplace in office-wide or enterprise-wide computer networks, intranets and the Internet.

When used in a LAN networking environment, the computer 720 is connected to the local network 751 through a network interface or adapter 753. When used in a WAN networking environment, the computer 720 may include a modem 754, a wireless link, or other means for establishing communications over the wide area network 752, such as the Internet. The modem 754, which may be internal or external, is connected to the system bus 723 via the serial port interface 746. In a networked environment, program modules depicted relative to the computer 720, or portions thereof, may be stored in the remote memory storage device. It will be appreciated that the network connections shown are exemplary and other means of establishing communications over wide area network 752 may be used.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

We claim:

1. In a client system that supports a real-time electronic communication activity with a contact through one or more service providers, the one or more service providers each having separate user interfaces, the contact having at least one real-time communication address that corresponds to a particular service provider, a method of selecting an appropriate service provider for a given real-time electronic communication activity with the contact through a single user interface, the method comprising the acts of:
receiving a request for a real-time electronic communication activity directed to a contact, wherein said contact has at least one real-time address for at least one real-time electronic communication activity;
inquiring of one or more service providers whether each provider supports said at least one real-time communication activity with said contact;
identifying a subset of the one or more service providers that support said requested real-time electronic communication activity with said contact; and
selecting from said subset a service provider for said real-time electronic communication activity with said contact, without a user having to select said service provider prior to initiating said real-time electronic communication with said contact.

2. The method of claim 1, wherein selecting is based at least in part on a user's communication preference for the at least one real-time communication activity.

3. The method of claim 1, wherein selecting is based at least in part on said contact's communication preference for the at least one real-time communication activity.

4. The method of claim 1, wherein said at least one real-time communication activity comprises instant text messaging.

5. The method of claim 1, wherein said at least one real-time communication activity comprises audio.

6. The method of claim 5, wherein said audio communication includes telephonic, satellite, and local area network transmissions.

7. The method of claim 1, wherein said at least one real-time communication activity comprises chat.

8. The method of claim 1, further comprising an act of inquiring of a plurality of service providers whether each of said plurality supports said at least one real-time communication activity for said contact.

9. The method of claim 8 further comprising an act of inquiring of said service provider whether said contact is currently available for said supported at least one real-time communication activity.

10. The method of claim 1 further comprising storing whether an inquired communication activity is supported by one of said one or more service providers for future reference.

11. In a client system that supports a real-time electronic communication activity with a contact through one or more service providers, the one or more service providers each having separate user interfaces, the contact having at least one real-time communication address that corresponds to a particular service provider, a method of selecting an appropriate service provider for a given real-time electronic communication activity with the contact using a single user interface, the method comprising the steps for:
requesting a real-time electronic communication activity directed to a contact, wherein said contact has at least one real-time address for at least one real-time electronic communication activity;
determining which of one or more service providers support said requested real-time electronic communication activity for said contact to which a real-time electronic communication activity is directed;
producing a subset of the one or more service providers determined to support said requested real-time electronic communication activity; and
using said subset to select at least one service provider for at least one real-time electronic communication activity for said contact, without a user having to select said at least one service provider prior to initiating said at least one real-time electronic communication activity.

12. The method of claim 11, wherein selecting is based at least in part on a user's communication preference for the at least one real-time communication activity.

13. The method of claim 11, wherein selecting is based at least in part on said contact's communication preference for said at least one real-time communication activity.

14. The method of claim 11, wherein said at least one real-time communication activity comprises text communication.

15. The method of claim 11, wherein said communication activity comprises audio communication.

16. The method of claim 15, wherein said audio communication includes telephonic, satellite, and local area network facilitated transmissions.

17. The method of claim 11, wherein said at least one real-time communication activity comprises chat.

18. The method of claim 11, wherein the step for determining an appropriate service provider comprises an act of inquiring of each of the one or more service providers whether the provider supports at least one real-time communication activity for said contact.

19. The method of claim 11, wherein the step for producing a subset of the one or more service providers comprises an act of identifying a subset of the one or more service providers that support said requested real-time electronic communication activity with said contact.

20. The method of claim 11 further comprising storing whether a requested real-time communication activity is supported by one of said one or more service providers.

21. In a computerized system that supports a real-time electronic communication activity with a contact through one or more service providers, the one or more service providers each having separate user interfaces, the contact having at least one real-time communication address that corresponds to a particular service provider, a computer program product comprising a computer readable medium carrying computer-executable instructions for selecting an appropriate service provider for a given real-time electronic communication activity with the contact through a single user interface, the instructions comprising the acts of:
receiving a request for a real-time electronic communication activity directed to a contact, wherein said contact has at least one real-time address for at least one real-time electronic communication activity;
inquiring of one or more service provider whether each provider supports said at least one real-time communication activity with said contact;
for identifying a subset of the one or more service providers that support said requested real-time electronic communication activity with said contact; and
selecting from said subset a service provider for said real-time electronic communication activity with said contact, without a user having to select said service provider prior to initiating said real-time electronic communication with said contact.

22. The computer program product of claim 21, wherein selecting from said subset further comprises an act of selecting at least one service provider based at least in part on a user's communication preference for the at least one real-time communication activity.

23. The computer program product of claim 21, wherein selecting from said subset further comprises an act of selecting at least one service provider based at least in part on said contact's communication preference for the at least one real-time communication activity.

24. The computer program product of claim 21, further comprising an act of inquiring of a plurality of service providers whether each of said plurality of service providers supports said at least one real-time communication activity for said contact.

25. The computer program product of claim 24, further comprising instructions an act of inquiring of said service provider whether said contact is currently available for said supported at least one real-time communication activity.

26. The computer program product of claim 21, further comprising instructions for an act of storing whether an inquired communication activity is supported by said one or more service providers.

27. In a computerized system that supports a real-time electronic communication activity with a contact through one or more service providers, the one or more service providers each having separate user interfaces, the contact having at least one real-time communication address that corresponds to a particular service provider, a computer program product comprising a computer-readable medium carrying instructions for selecting an appropriate service provider for a given real-time electronic communication activity with the contact using a single user interface, the instructions comprising the steps for:
requesting a real-time electronic communication activity directed to a contact, wherein said contacts has at least one real-time address for at least one real-time electronic communication activity;
determining which of one or more service providers support said requested real-time electronic communication activity for said contact to which a real-time electronic communication activity is directed;
producing a subset of the one or more service providers determined to support said requested real-time electronic communication activity; and
using said subset to select at least one service provider for at least one real-time electronic communication activity for said contact, without a user having to select said at least one service provider prior to initiating said at least one real-time electronic communication activity.

28. The computer program product of claim 27, wherein the step for using said subset further includes an act of selecting at least one service provider based at least in part on a user's communication preference for the at least one real-time communication activity.

29. The computer program product of claim 27, wherein the step for using said subset further includes an act of selecting at least one service provider based at least in part on said contact's communication preference for the at least one real-time communication activity.

30. The computer program product of claim 27, wherein the step for determining which service providers support said requested real-time electronic communication activities comprises the act of inquiring of each of the one or more service providers whether the provider supports said at least one real-time communication activity for said contact.

31. The computer program product of claim 27, wherein the step for producing a subset of the one or more service providers comprises an act of identifying a subset of the one or more service providers that support said requested at least one real-time electronic communication activity with said contact.

32. The computer program product of claim 27 further comprising storing which of one or more service providers supports said at least one real-time communication activity.

33. The computer program product of claim 27, wherein the step for producing a subset of the one or more service providers further comprises prioritizing the subset of the one or more service providers.
